(19) United States
(12) Patent Application Publication
(10) Pub. No.: US 2015/0140885 A1
(43) Pub. Date: May 21, 2015

(54) INSULATING TAPE MATERIAL, METHOD FOR PRODUCTION AND USAGE THEREOF

(71) Applicant: SIEMENS AKTIENGESELLSCHAFT, Munchen (DE)

(72) Inventors: Florian Eder, Erlangen (DE); Peter Gröppel, Erlangen (DE); Michael Preibisch, Furth (DE); Claus Rohr, Mannheim (DE)

(21) Appl. No.: 14/399,243

(22) PCT Filed: Apr. 4, 2013
(86) PCT No.: PCT/EP2013/057127

§ 371 Date: Nov. 6, 2014

(30) Foreign Application Priority Data
May 7, 2012 (DE) 10 2012 207 535.6

(51) Int. Cl. D06M 11/45; H02K 3/30; H02K 3/40; D03D 15/00; H01B 3/10

(52) U.S. Cl. CPC D06M 11/45; D03D 15/0011; H01B 3/10; H02K 3/40; H02K 3/30; D06M 2101/16
USPC 442/136; 442/59; 442/180; 427/180; 427/532; 264/131

(57) ABSTRACT

An insulating tape material, a method for production and usage thereof, for producing electrical insulation paper such as mica paper, which is contained in thermally conductive insulating tapes that are used for high-voltage insulation, for example. The insulating tape material has fiber reinforcement by means of a fabric, wherein the meshes of the fabric are filled by a particle composite which is preferably thermally conductive.

### CROSS-REFERENCE TO RELATED APPLICATIONS

The present application is a 35 U.S.C. §§371 National Phase conversion of PCT/EP2013/057127, filed Apr. 4, 2013, which claims priority of German Patent Application No. 10 2012 207 535.6, filed May 7, 2012, the contents of which are incorporated by reference herein. The PCT International Application was published in the German language.

### TECHNICAL FIELD

The invention relates to an insulating tape material, in particular such a material for the production of electrical insulation paper such as mica paper, which is contained in thermally conductive insulating tapes that are used for example for high-voltage insulations.

### TECHNICAL BACKGROUND

Thermally conductive insulating tapes are used for example as main insulators for protection from overvoltages and/or disruptive discharges of electric motors, high-voltage machines and/or (high-voltage) generators.

Electrical machines, such as for example motors and generators, have electrical conductors, an electrical insulation and a laminated stator core. The insulation has the purpose of electrically insulating the conductors from one another, from the laminated stator core and from the surroundings. Under mechanical or thermal loading during the operation of the machine, voids in which sparks can form due to partial electrical discharges may form at the interfaces between the insulation and the conductor or between the insulation and the laminated stator core. The sparks may cause what are known as “treeing” channels in the insulation. As a consequence of the “treeing” channels, there may be a disruptive electrical discharge through the insulation. A barrier against the partial discharges is achieved by using mica in the insulation, which has a high resistance to partial discharges. The mica is used in the form of platelet-like mica particles, with a conventional particle size of several 100 micrometers to several millimeters, and the mica particles are processed into a mica paper.

In the production of mica paper, the platelet-like mica particles are arranged in layers, so that the particles are arranged largely parallel to one another. Mica particles that lie directly on top of one another overlap to form contact surfaces. As a consequence of van der Waals forces and hydrogen bridge bonds, interactions that give the mica paper a high mechanical load-bearing capacity, and consequently a stable form, form between the contact surfaces.

In the production of the insulation, the mica paper is wound around the conductor to be insulated and is impregnated with a resin. Subsequently, the composite comprising the resin and the mica paper is cured. In addition, the mica paper may be applied to a backing fabric of glass or polyester, the backing fabric lending the mica paper additional stability. An adhesive bonds the backing fabric and the mica paper to form a mica tape. To avoid high temperatures in the conductor during the operation of the machine, heat must be dissipated from the conductor into the surroundings. The thermal conductivity of the mica paper is only about 0.2 to 0.25 W/mK at room temperature, with the effect of hindering the heat dissipation from the electrical conductor.

An improvement in the heat conduction could be achieved both by reducing the thickness of the insulation and by improved thermal conductivity of the insulation. The use of platelet-like alumina particles instead of the platelet-like mica particles is known, alumina having a much higher thermal conductivity than mica at about 25 to 40 W/mK.

There are already known insulating tapes that comprise for example a woven fabric and mica, with an adhesive bonding the two components to form a protective mica tape.

However, due to the combination of inorganic and polymeric materials, the initially high thermal conductivity of the inorganic mica is also reduced. The thermal conductivity of usually used mica tape impregnated with epoxy resins, with a glass or polyester fabric as backing material, is about 0.2-0.25 W/mK at room temperature, whereas that of pure mica is at about 0.5 Wm/K.

Consequently, although the current system structure and the associated production process are well-suited for ensuring a sufficiently lasting electrical insulating effect, the heat dissipation from the electrical conductor is hindered by the rather more thermally insulating properties of the material composite.

EP11164882, is incorporated herein by reference such that the disclosure is part of the present description, discloses a method for producing a porous particle composite for an electrical insulating paper with the following steps: mixing a dispersion of platelet-like particles, a carrier fluid and a functionalizing agent, which is distributed in the carrier fluid and has a mass fraction in the dispersion that corresponds to a predetermined mass ratio relative to the mass fraction of the particles; generating a sediment by sedimenting the dispersion, whereby the platelet-like particles are arranged in a substantially layer-like, plane-parallel manner in the sediment; removing the carrier fluid from the sediment; and introducing energy into the sediment to overcome the activation energy of the chemical reaction of the functionalizing agent with the particles that forms the particle composite from the sediment, with coupling of the particles via the functionalizing agent, the mass ratio being predetermined in such a way that the particle composite has a porous structure. The coupling of the particles taking such a form intensifies the interactions of the particles with one another, so that the particle composite advantageously has a sufficient strength for producing paper.

A disadvantage of the method is that, although a mica-alumina tape is produced by filtration processes, it is subsequently bonded to a strength-increasing fiber support, using an adhesive that generally fills the meshes of the strength-increasing fiber composite. The polymeric filling of the meshes of the fiber composite with polymer that is not thermally conductive has the effect of restricting the thermal conductivity of the system as a whole.

### BRIEF DESCRIPTION OF THE DRAWINGS

The invention is further explained in more detail below on the basis of two figures, which schematically show an advantageous embodiment of the invention:

FIG. 1 shows the scanning electron micrographs of an alumina-glass fiber material that has been produced according to the invention.

The fabric of a network-like structure with the formation of meshes can be seen, the meshes being filled by platelet-like particles.

FIG. 2 shows a detail from FIG. 1, depicting a filled mesh of the network-like fabric.

### DESCRIPTION OF THE INVENTION

The object of the present invention is therefore to align the arrangement of platelet-like thermally conductive particles in a fiber composite, in particular align them in parallel, so that thermal conductivity paths form within the fiber composite.

The solution for achieving the object and the subject of the present invention is an insulating tape material comprising a particle composite and a woven fabric, the interstices of the fabric being filled with the particle composite. Also the subject of the invention is a method for producing a filled insulating tape, comprising the following process steps: mixing a dispersion of platelet-like particles with a carrier fluid; generating a sediment by sedimenting the dispersion, whereby the platelet-like particles are arranged in a substantially layer-like, plane-parallel manner in the sediment; introducing a fabric into the sediment and removing the carrier fluid from the sediment. Finally, use of the insulating tape material for producing an insulation for protection from overvoltages and/or disruptive discharges of electric motors, high-voltage machines and/or (high-voltage) generators is the subject of the invention.

According to an advantageous refinement of the invention, the fabric takes a network-like form, so that there are meshes in the network structure.

According to an advantageous embodiment of the invention, the particle composite comprises platelet-like particles, in particular preferably with an aspect ratio of at least 50, that is to say the ratio of platelet length to platelet thickness is at least 50.

According to a further embodiment, the platelet-like particles of the particle composite have good heat conduction.

According to an advantageous embodiment of the method, when mixing the dispersion of platelet-like particles with the carrier fluid, also added is a functionalizing agent, which is distributed in the carrier fluid and has a mass fraction in the dispersion that corresponds to a predetermined mass ratio relative to the mass fraction of the particles.

Before the mixing of the dispersion, the particles are preferably formed with a substantially monomolecular thin layer on the surface of the particles, the thin layer being produced from a further functionalizing agent. The chemical reaction for coupling the particles takes place between the thin layer and the functionalizing agent.

Alternatively, particles which have a substantially monomolecular thin layer that is different from the thin layer of the particles that are originally present in the dispersion are preferably added to the dispersion of the particles with the substantially monomolecular thin layer and the carrier fluid. The chemical reaction for coupling the particles takes place between two or more different thin layers.

The particles are preferably chosen such that they comprise alumina. One advantage of alumina is its high thermal conductivity in comparison with mica.

According to a further advantageous embodiment of the method, after the removal of the carrier fluid from the sediment there is a further process step, in which energy is introduced into the sediment to overcome the activation energy of the chemical reaction of the functionalizing agent with the particles that forms the particle composite from the sediment, with coupling of the particles via the functionalizing agent, the mass ratio being predetermined in such a way that the particle composite has a porous structure. The coupling of the particles taking such a form intensifies the interactions of the particles with one another, so that the particle composite advantageously has a sufficient strength for producing paper and forms thermal conductivity paths.

The functionalizing agent is preferably chosen such that it is a plastic, in particular a thermoplastic. The plastic is preferably chosen such that it is a polyolefin alcohol, in particular polyethylene glycol or a not completely hydrolyzed polyvinyl alcohol with a molecular mass of between 1000 and 4000, or a polyalkylsiloxane, in particular methoxy-terminated polydimethylsiloxane, or a silicone polyester. Furthermore, the functionalizing agent is preferably chosen such that it is an alkoxysilane and forms a substantially monomolecular thin layer on the particle surface. The alkoxysilane is perfectly chosen such that it comprises epoxy groups, in particular 3-glycidoxypropyltrimethoxysilane, or amino groups, in particular 3-aminopropyltriethoxysilane. Furthermore, the functionalizing agent is preferably chosen such that it comprises particles, in particular nanoparticles of silica, that carry superficial epoxide functionalities.

The method according to the invention is preferably carried out such that the energy for overcoming the activation energy is supplied to the sediment with the fabric in the form of heat and/or radiation. Furthermore, the method according to the invention is preferably carried out such that the removal of the carrier fluid takes place by filtration and subsequently supplying heat. The removal of the solvent by supplying heat and the supplying of heat to overcome the activation energy can advantageously take place in one method step. In this case, the carrier fluid is preferably chosen such that it is water.

According to an advantageous embodiment, the removal of the sediment after adding the fabric takes place by filtration, so that the platelet-like particles are sucked through the fabric.

Introducing the fabric has the effect that a mechanical intermeshing of the sediment with the fabric is produced. This not only simplifies the production process, but also creates a better thermal coupling of the alumina to the fabric.

The carrier fluid is preferably a solvent in which the functionalizing agent is soluble, the functionalizing agent being dissolved in the solvent. The functionalizing agent is preferably chosen such that it forms a substantially monomolecular thin layer on the surface of the particles. The chemical reaction for coupling the particles takes place between the thin layers. The fabric has a poorer thermal conductivity in comparison with the platelet-like particles, for example alumina and/or mica particles, and therefore restricts the overall thermal conductivity of the composite according to the prior art. Moreover, after the impregnation according to the prior art, the meshes in the network of the fabric are filled with adhesive, so that the heat flow is greatly hindered at these locations. Thus, if, by modifying the production process, these fabric meshes are filled with heat-conducting particles, that is to say for example with alumina particles, bridges with good thermal conductivity form in the fabric meshes or fiber interstices, so that the overall thermal conductivity of the composite increases. Tests have shown that, as a result, the overall thermal conductivity of an impregnated-through alumina-glass fabric composite is increased from 0.4 W/mK to 0.48 W/mK. This is equivalent to an increase in the thermal conductivity of 20%.

### DESCRIPTION OF AN EMBODIMENT

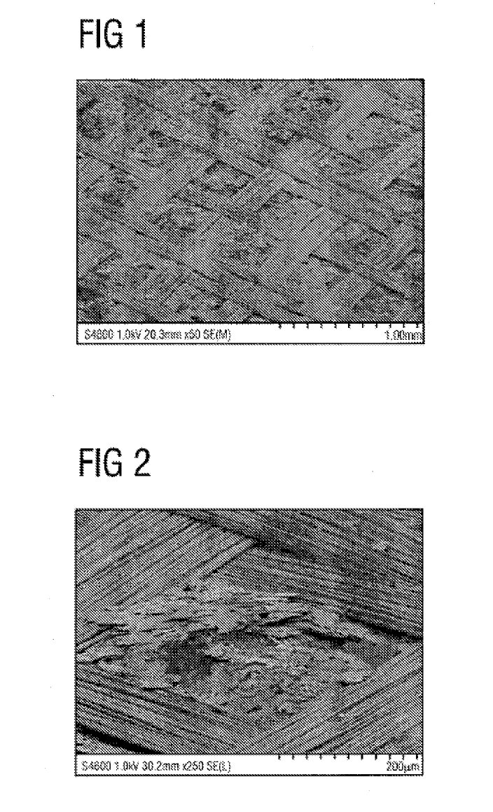

According to the prior art, the meshes shown in FIGS. 1 and 2 are filled with adhesive, which is generally poorly heat-conducting, because the bond between the platelet-like particles and the fabric only took place after producing the advantageously porous particle composite according to EP11164882 by adding the network-like fabric and an adhesive.

The invention relates to an insulating tape material, a method for production and use thereof, in particular such a material for the production of electrical insulation paper such as mica paper, which is contained in thermally conductive insulating tapes that are used for example for high-voltage insulations. The insulating tape material has a fiber reinforcement provided by a fabric, the meshes of the fabric being filled by a—preferably thermally conductive—particle composite.

1. An insulating tape material comprising a particle composite and a woven fabric, the fabric has interstices and the interstices are filled with the particle composite.

2. The insulating tape material as claimed in claim 1, wherein the fabric has a network-like structure.

3. The insulating tape material as claimed claim 1, wherein the fabric comprising glass fibers.

4. The insulating tape material as claimed in claim 1, wherein particles of the particle composite have an aspect ratio of greater than/equal to 50.

5. The insulating tape material as claimed in claim 1, wherein the particle composite comprises particles of a material with good heat conduction.

6. The insulating tape material as claimed in claim 1, wherein the particle composite comprises alumina particles.

7. The insulating tape material as claimed in claim 1, wherein the particle composite comprises a functionalizing agent.

8. A method for producing a filled insulating tape, comprising the following process steps:
mixing a dispersion of platelet-like particles with a carrier fluid;
generating a sediment by sedimenting the dispersion, for causing the platelet-like particles to be arranged in a substantially layer-like, plane-parallel manner in the sediment; and
introducing a fabric into the sediment and then removing the carrier fluid from the sediment.

9. The method as claimed in claim 8, wherein removing the carrier fluid from the sediment is performed at least partially by filtration.

10. The method as claimed in claim 8, further comprising:
adding a functionalizing agent to the mixture, which mixture comprises the dispersion and the carrier fluid.

11. The method as claimed in claim 8, further comprising following the removal of the carrier fluid from the sediment, introducing energy into the sediment to overcome activation energy of the chemical reaction of the functionalizing agent with the particles, for forming the particle composite from the sediment, along with coupling of the particles via the functionalizing agent.

12. A method of forming an insulating tape material as claimed in claim 1 and positioning and shaping the tape for producing an insulation for protection from overvoltages and/or disruptive discharges of any of electric motors, high-voltage machines and/or (high-voltage) generators.

13. The insulating tape material as claimed in claim 1, wherein the particle composite comprises particles of a material with good heat conduction; and
the particle composite comprises a functionalizing agent.
